(19) United States
(12) Patent Application Publication
(10) Pub. No.: US 2013/0054342 A1
(43) Pub. Date: Feb. 28, 2013

(54) ADVERTISING BONUS SYSTEM

(71) Applicant: Shen-Chang TSENG, Taipei (TW)

(72) Inventor: Shen-Chang TSENG, Taipei (TW)

(73) Assignee: YAHOO! INC., Sunnyvale, CA (US)

(21) Appl. No.: 13/222,994

(22) Filed: Aug. 31, 2011

(51) Int. Cl. G06Q 30/00

(52) U.S. Cl. 705/14.32

(57) ABSTRACT

A bonus points system and a corresponding method are disclosed. First, the bonus points system records user activities on a first computer system managing a first online service that is accessible to all users. Second, the bonus points system awards points to a user when a predetermined activity is recorded. Third, the bonus points system exchanges points between the two computer systems when receiving an exchange request. Fourth, the bonus points system grants the user access to a second online service in the second computer system based on an amount of points of the user in the second computer system. The bonus points system allows an advertiser to buy points to display ads and award points to users performing the predetermined activity on the displayed ads. The second computer system is configured to manage points related to the second online service that is accessible to paid users.

### BACKGROUND

Online advertising is becoming more and more popular in recent years. Most websites display ads to their users and try to get attention from them. However, most users do not like viewing or clicking the displayed ads.

There is a need to create a system that encourages and benefits the interactions between advertisers and users.

### SUMMARY

In this disclosure, we build a bonus point management system that provides communications among an advertising system and systems providing other services. The advertising system in the point management system encourages users to click on the ads by awarding points. The bonus point management system allows users to pay points for other paid services. Advertisers may also buy points and award users who click on the ads or perform other predetermined activities.

One embodiment discloses a computer implemented method or program for providing a bonus points system. The bonus points system includes at least two computer systems and includes the following steps. First, the bonus points system records user activities on a first computer system managing a first online service. Second, the bonus points system awards points to a user when a predetermined activity is recorded. Third, the bonus points system exchanges points between the first computer system and a second computer system when receiving an exchange request from the user. Fourth, the bonus points system grants the user access to a second online service in the second computer system based on an amount of points of the user in the second computer system. The bonus points system allows an advertiser to buy points to display ads and award points to users performing the predetermined activity on the displayed ads. The first computer system is configured to manage points related to the first online service that is accessible to all users. The second computer system is configured to manage points related to the second online service that is accessible to paid users. The computer implemented method or program may be stored in any computer-readable storage medium accessible by the computer system.

Another embodiment discloses a computer system having a processor configured to manage points for a first online service in a first computer system and a second service in a second computer system. The processor first records user activities on the first online service. The processor then awards points to a user when a predetermined activity is recorded. The processor exchanges points between the first computer system and the second computer system when receiving an exchange request from the user. The processor grants the user access to the second online service based on an amount of points the user has in the second computer system. The processor allows an advertiser to buy points to display ads and award points to users performing the predetermined activity on the displayed ads.

### BRIEF DESCRIPTION OF THE DRAWINGS

FIG. 1 illustrates a block diagram of one embodiment of an environment in which an advertising bonus system may operate;

FIG. 2 illustrates an embodiment of the advertising bonus system; and

FIG. 3 illustrates a flow chart of a computer implemented method that provides a bonus points system.

### DETAILED DESCRIPTION OF THE DRAWINGS

Online advertising needs attention from users to be more effective. An effective advertising system can bring more services to meet users' demand. The advertising bonus points system uses points to increase the interaction between advertisers and users. Points are exchanged between advertisers and users when users perform predetermined activities. Users may combine their points earned from different websites or companies. Users may then use the combined points to get more services they like.

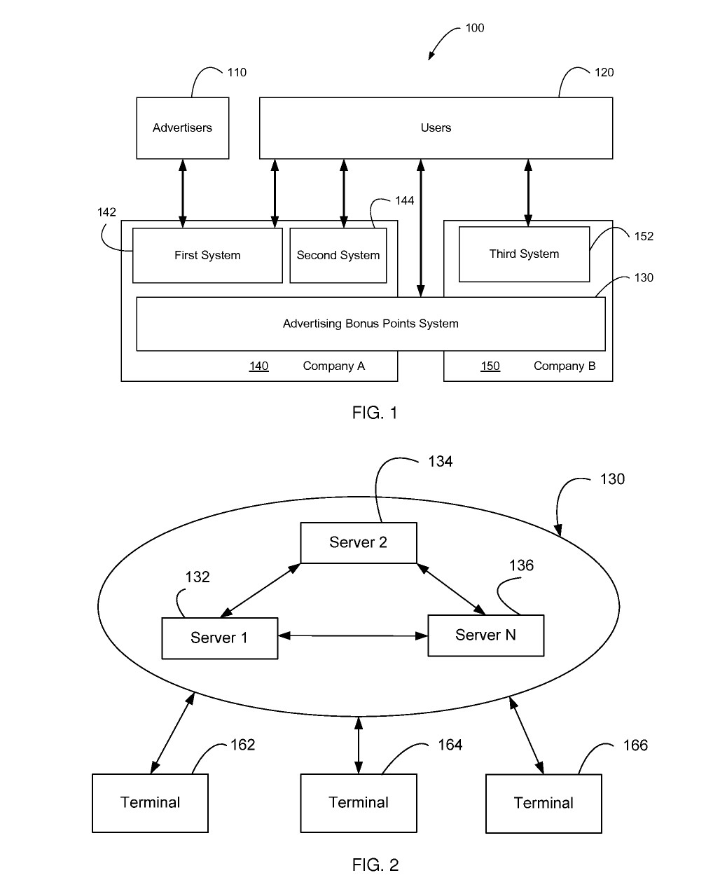

FIG. 1 is a block diagram of one embodiment of an environment 100 in which an advertising bonus system may operate. However, it should be appreciated that the systems and methods described below are not limited to use with the particular embodiment.

The environment 100 may include multiple computer systems, for example, a first computer system 142 and a second computer system 144 from company A and a third computer system 152 from company B. The first computer system 142 and the second computer system 144 may be implemented in a server or in multiple servers. The first computer system 142 may interact with advertisers 110 through any human machine interface in a computing device such as a computer, a smart phone, a tablet, an internet TV, or any other device that has at least a processor. Conventionally, such computing devices generally include an interface, a memory storing data and instructions and a processor in data communication with the memory to execute instructions using data stored in the memory and received at the interface.

The first computer system 142 provides users 120 with free content such as general news, general email service, or any other free services. The advertising bonus points system 130 allows advertisers 110 to buy points to display ads and award points to users 120 performing the predetermined activity on the displayed ads. Advertisers 110 may pay company A to display their ads to the users through the first computer system 142. For example, users 120 may view the displayed ads when they use the free email services or read the free news on company A's general website that is accessible to all users free of charge. Advertisers 110 may also buy more points from the advertising bonus points system 130. Users 120 may get points from the advertisers 110 by interacting with the displayed ads. For example, users may get points by answering questions related to the displayed ads or by clicking the displayed ads. Advertisers 110 may also provide other incentives to users 120 when they perform similar predetermined activities. For example, the predetermined activity may further include at least one of the following: browsing the displayed ads, clicking the displayed ads, answering a question related to the displayed ads, joining a sponsored discussion, and leaving comments.

The first computer system 142 is configured to manage points related to the free online service that is accessible to all users. The advertising bonus points system 130 may present a question about the displayed ads to the user when the predetermined activity is recorded. The advertising bonus points system 130 awards points to the user if the user answers the presented question correctly. The first computer system 142 is configured to enable advertisers 110 to customize awarded points for each question. Additionally or alternatively, the first computer system 142 is configured to enable advertisers 110 to customize questions to a user based on the user's background.

The second computer system 144 provides users 120 with paid services such as detailed financial news, dedicated online storage and email services, or any other services that company A may charge users 120 a fee to access. The second computer system 144 may grant points to users 120 when they pay for the service upfront. The granted points are deducted when users 120 use the paid services on the second computer system 144. The second computer system 144 is configured to manage points related to the second online service that is accessible to paid users. A user may use his points earned from the first computer system 142 to pay for the services on the second computer system 144. Additionally, the advertiser may user his points to pay for the paid services for some users. The advertiser may also use points to display desired ads in the first computer system.

The advertising bonus points system 130 is configured to communicate between the first and second computer systems 142 and 144. Accordingly, the advertising bonus points system 130 may include one or more processors and memory and one or more data communication interfaces. An embodiment of the advertising bonus points system 130 will be described in greater detail below in conjunction with FIG. 2. The advertising bonus points system 130 is also configured to exchange points between the first and second computer systems 142 and 144 when receiving an exchange request from a user. The bonus point system 130 grants the user access to the paid online service based on an amount of points of the user in the second computer system 144.

With the advertising bonus points system 130, users 120 may exchange points between the first computer system 142 and the second computer system 144 by submitting a request to the advertising bonus points system 130. The advertising bonus points system 130 may determine the exchanging rate based on predetermined conditions or an agreement with advertisers 110. The predetermined conditions may be related to the specific paid services provided by the second computer system 144. Additionally or alternatively, the predetermined conditions may be related to other reasonable factors such as popularity of the first and second online services among users, cost to provide the second online service, or similarity between the first and second online services.

The third computer system 152 may belong to a company B. For example, both company A and company B may be online service providers providing different online services such as email services, photo sharing services, video sharing services, and online computing services. The advertising bonus points system 130 is further configured to communicate among the first, second, and third computer system 142, 144, and 152. The third computer system 152 may provide free services, paid services, or a combination of free and paid services. For example, the third computer system 152 may provide online video streaming services having both free and paid content. Users 120 may buy points directly from the company B to access the paid services on the third computer system 152. Alternatively or additionally, users 120 may exchange points they earned from the first computer system 110 to points that can be used to access the services provided by the third computer system 152.

FIG. 2 illustrates an embodiment of the advertising bonus system 130 in FIG. 1. The advertising bonus points system 130 may be implemented in a server or in a plurality of servers 132, 134, and 136. Each of the servers may be a computer, a server, or any other computing device known in the art. The plurality of servers 132, 134, and 136 may be a computer program, instructions, and/or software code stored on a computer-readable storage medium that runs on a processor of a single server, a plurality of servers, or any other type of computing device known in the art. One of the servers 132, 134, and 136 may also be a virtual machine running a program that delivers content. One of the servers 132, 134, and 136 may be a search engine configured to help users find information located both inside and outside of the online group. One of the servers 132, 134, and 136 may be an advertisement server configured to provide digital ads to a web user based on display conditions requested by the advertiser. One of the servers 132, 134, and 136 may be an email server configured to provide free email services to all users. One of the servers 132, 134, and 136 may be a server configured to provide paid services to users have the predetermined amount of points.

The advertisers and other users may access the advertising bonus points system using a plurality of terminals 162, 164, and 166. Each terminal of the plurality of terminals 162, 164, and 166 may be a computer, a smart phone, a personal digital aid, a digital reader, a Global Positioning System (GPS) receiver, a smart TV, or any other terminal that may be used to access the servers.

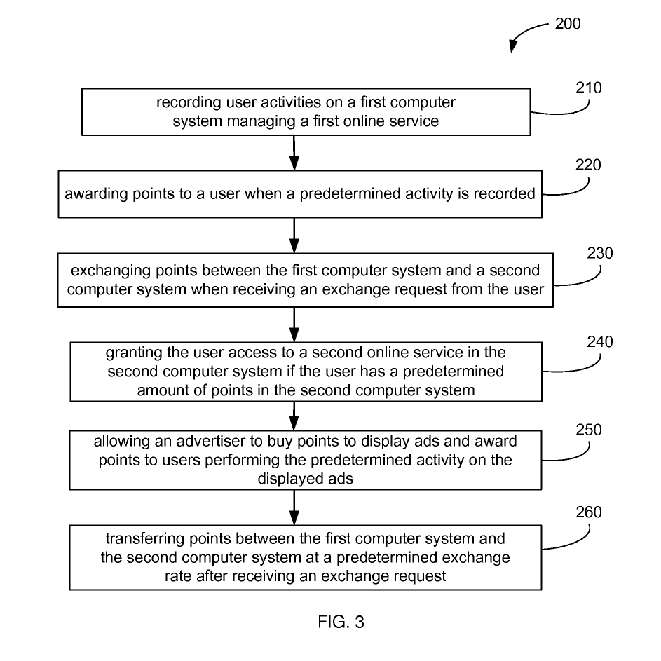

FIG. 3 illustrates a flow chart 200 of a computer implemented method that provides a bonus points system. The advertising bonus points system includes computers with processors and computer readable media such as hard disk, computer memory, or other data storage hardware. A user may access the computer system on a mobile device such as a smart phone, a tablet, an internet ready TV, or any other device that can access internet. The computer implemented method may include the following steps. Other steps may be added or substituted.

In step 210, the advertising bonus points system records user activities on a first computer system managing a first online service. The first computer system is configured to provide a first online service and manage points related to the first online service that is accessible to all users. The advertising bonus points system may record user activities once the user agrees to share such information with the advertising bonus points system. The recorded activities may include clicking activities, browsing activities, or any other activities advertisers are interested and users allow to share.

In step 220, the advertising bonus points system awards points to a user when a predetermined activity is recorded. The predetermined activity may be customized by advertisers. Additionally or alternatively, the predetermined activity may be customized by advertisers and the advertising bonus points system based on available user information such as age and gender.

In step 230, the advertising bonus points system exchanges points between the first computer system and a second computer system when receiving an exchange request from the user. The second computer system is configured to provide a second online service and manage points related to the second online service that is accessible to paid users.

In step 240, the advertising bonus points system grants the user access to the second online service in the second computer system based on an amount of points of the user in the second computer system. The second online service may be provided by the same company that provides the first online service. Alternatively, the second online service may be provided by a different company.

In step 250, the advertising bonus points system allows an advertiser to buy points to display ads and award points to users performing the predetermined activity on the displayed ads. The advertiser may be a user that has earned points from the advertising bonus points system. At the same time, the advertiser may create additional conditions under which the user will be awarded points. The advertiser may also put a maximum limit on the amount of points each user can earn in a predetermined period of time. Alternatively or additionally, the advertiser may also put a maximum limit on the amount of points each terminal device can be used to earn in a predetermined period of time.

In step 260, the advertising bonus points system transfers points between the first computer system and the second computer system at a predetermined exchange rate after receiving an exchange request. The predetermined exchange rate may be adjusted from time to time as requested by advertisers or by the advertising bonus points system.

Additionally, the advertising bonus points system may present a question to the user when a predetermined activity is recorded. The question may relate to the displayed ads. The advertising bonus points system awards points to the user if the user answers the presented question correctly.

In summary, the bonus points system may be implemented in a computer or other computing devices that communicate with a plurality of online service providers. The bonus points system helps users to organize their virtual points earned from different online activities on different websites. The user can then use the organized virtual points more efficiently for any online services that accept the virtual points.

The disclosed computer implemented method may be stored in computer-readable storage medium. The computer-readable storage medium is accessible to at least one processor such as a CPU. The processor is configured to implement the stored instructions to implement an online bonus points system.

From the foregoing, it can be seen that the present embodiments provide a novel solution to improve the user online experience and the efficiency of online ads. The disclosed embodiments encourage users to click and read the online ads by awarding points to them. The awarded points may be exchanged or combined. Users can then use the awarded points to buy other services from any service provider.

It is therefore intended that the foregoing detailed description be regarded as illustrative rather than limiting, and that it be understood that it is the following claims, including all equivalents, that are intended to define the spirit and scope of this invention.

We claim:

1. A computer implemented method for providing a bonus points system, comprising:
recording, in the bonus points system, user activities on a first computer system managing a first online service;
awarding points to a user when a predetermined activity is recorded;
exchanging points between the first computer system and a second computer system when receiving an exchange request from the user;
granting the user access to a second online service in the second computer system based on an amount of points of the user in the second computer system; and
allowing an advertiser to buy points to display ads and award points to users performing the predetermined activity on the displayed ads,
wherein the first computer system is configured to manage points related to the first online service that is accessible to all users, and the second computer system is configured to manage points related to the second online service that is accessible to paid users.

2. The method of claim 1 further comprising: transferring points between the first computer system and the second computer system at a predetermined exchange rate after receiving an exchange request.

3. The method of claim 1, wherein the predetermined activity comprises at least one of the following: browsing the displayed ads, clicking the displayed ads, answering a question related to the displayed ads, joining a sponsored discussion, and leaving comments.

4. The method of claim 1 further comprising: presenting a question to the user when the predetermined activity recorded, wherein the question relates to the displayed ads.

5. The method of claim 4 further comprising: awarding points to the user if the user answers the presented question correctly.

6. The method of claim 5, wherein the first computer system is configured to enable the advertiser to customize awarded points for each question.

7. The method of claim 6, wherein the first computer system is configured to enable the advertiser to customize questions to the user based on the user's background.

8. A computer-readable storage medium storing a set of instructions for an bonus points system, the set of instructions to direct a processor to:
record, in the bonus points system, user activities on the first online service;
award points to a user when a predetermined activity is recorded;
exchange points between the first computer system and a second computer system when receiving an exchange request from the user;
grant the user access to a second online service in the second computer system based on an amount of points of the user in the second computer system; and
allow an advertiser to buy points to display ads and award points to users performing the predetermined activity on the displayed ads,
wherein the first computer system is configured to manage points related to the first online service and the second computer system is configured to manage points related to the second online service.

9. The storage medium of claim 8, wherein the set of instructions directs the processor to transfer points between the first computer system and the second computer system at a predetermined exchange rate after receiving an exchange request.

10. The storage medium of claim 8, wherein the predetermined activity comprises at least one of the following: browsing the displayed ads, clicking the displayed ads, answering a question related to the displayed ads, joining a sponsored discussion, and leaving comments.

11. The storage medium of claim 8, wherein the set of instructions directs the processor to present a question to the user when the predetermined activity recorded, and wherein the question relates to the displayed ads.

12. The storage medium of claim 11, wherein the set of instructions directs the processor to award points to the user if the user answers the presented question correctly.

13. The storage medium of claim 12, wherein the second computer system is configured to enable the advertiser to customize awarded points for each question.

14. The storage medium of claim 13, wherein the first computer system is configured to enable the advertiser to customize questions to the user based on the user's background.

15. A computer system comprising:
a processor configured to manage points for a first online service in a first computer system and a second service in a second computer system,
wherein the processor records user activities on the first online service;
wherein the processor awards points to a user when a predetermined activity is recorded;
wherein the processor exchanges points between the first computer system and the second computer system when receiving an exchange request from the user;
wherein the processor grants the user access to the second online service based on an amount of points the user has in the second computer system; and
wherein the processor allows an advertiser to buy points to display ads and award points to users performing the predetermined activity on the displayed ads.

16. The system of claim 15, wherein the processor transfers points between the first computer system and the second computer system at a predetermined exchange rate after receiving an exchange request.

17. The system of claim 15, wherein the predetermined activity comprises at least one of the following: browsing the displayed ads, clicking the displayed ads, answering a question related to the displayed ads, joining a sponsored discussion, and leaving comments.

18. The system of claim 17, wherein the system presents a question to the user when the predetermined activity recorded, and wherein the question relates to the displayed ads.

19. The system of claim 18, wherein the system awards points to the user if the user answers the presented question correctly.

20. The system of claim 19, wherein the first computer system is configured to enable the advertiser to customize awarded points for each question, and wherein the first computer system is configured to enable the advertiser to customize questions to the user based on the user's background.
